(19) United States
(12) Patent Application Publication
(10) Pub. No.: US 2006/0155584 A1
(43) Pub. Date: Jul. 13, 2006

(54) System and Method for Patient Identification, Monitoring, Tracking, and Rescue

(76) Inventor: Abhinav Aggarwal, Chapel Hill, NC (US)

Correspondence Address: DR. ABHINAV AGGARWAL, 100 SAINT AYERS WAY, CHAPEL HILL, NC, 27517, US

(21) Appl. No.: 11/307,487

(22) Filed: Feb. 9, 2006

Related U.S. Application Data
(63) Continuation-in-part of application No. 10/735,333, filed on Dec. 12, 2003, now abandoned.
(60) Provisional application No. 60/657,823, filed on Feb. 18, 2005.

(51) Int. Cl. G06F 19/00

(52) U.S. Cl. 705/3

(57) ABSTRACT

A system and method for uniquely identifying each patient, monitoring, tracking and rescue, when admitted to any hospital, nursing home or health care providing facility. The patient identification is done by issue of a Unique Patient Identification Number (PIN). Patient monitoring is done by collection of critical parameters and comparison with a reference scale. Patient tracking is achieved by integration of the software with a suitable transmission/reception system and patient-wearable tracking device. Patient rescue is achieved by dispatch of rescue teams, as and when needed, upon notification by the system. This shall be done in a manner that protects the confidentiality and privacy of the patient. This system would help in saving the lives of at-risk and other patients, and improve patient safety. The system shall result in advance preparedness at hospitals to deal with an emergency, by providing access to patient data, speeding up diagnostics and treatment. The data collected at hospitals can be stored in a database for access. The unique PIN (Patient Identification Number) can be linked to UIN (Universal Identification Number) system for persistent patient data access over the global network. The data can only be accessed by “authorized” health care providers on a “need to know” basis.

Unique Patient Identification and Tracking System (UPITS) is a system and method to identify, monitor, track, and rescue patients globally. The purpose is to build a patient data capturing mechanism, link that to a tracking system, monitor patient movements, raise alert when the patient has drifted to ‘out-of-bound’ areas or suffers from an abnormality, rescue the patient, and help in speeding diagnosis and treatment by providing access to patient records to the authorized hospitals/doctors/paramedics or health care providers. These records, individually related to a specific PIN (Patient Identification Number), irrespective of where collected, can be linked on a global basis by referencing with UIN (Universal Identification Number). The UIN acts as a GRI (Global Reference Indicator) for inter linkage of these patient records. This inter linkage shall help in cross-referencing patient records across nations on a global basis, thus helping in speeding up the diagnosis and treatment process. This inter linkage is provided by linking PIN (Patient Identification Number) with UIN. PIN is issued to the patient for each hospital visit and is a non-persistent (in other words, PIN is active only during stay/admission to hospital and is issued upon a patient visit to the hospital). Though all patient diagnosis, tests, observations, and lab records are linked to PIN when a patient visits a hospital, and PIN is active during visit/stay at hospital, the PIN and its associated records are archived when the patient is discharged from the hospital. These archived records and all active PIN records are referenced to UIN. When a physician needs to perform a diagnosis and requires access to the relevant current and previous records and medical history of the patient, that is instantaneously provided with this system by retrieving records from globally interlinked medical databases by UIN cross-reference. Reference to UIN from all PIN records ensures global interoperability, retrieval, transfer, and access to patient data to help speed up the diagnostic and treatment process.

PIN (Patient Identification Number) is an essential part of the UPITS and is the key identifier for capturing, storing, accessing and retrieving patient medical records. PIN comprises of various fields that help to uniquely identify a facility, its location, date and the order of record capture. The method is so designed that it eliminates the scope for an anomaly while capturing the patient data and records.

The format of the PIN record comprises of the fields that uniquely relate the patient to facility and sequence of data capture at the facility. The PIN consists of two major portions: FIN and PRN. In the following description, a stands for alphabetical, and n stands for numeric.

FIN (Facility Identification Number) contains these fields: Country Code, State Code, County Code, Facility Type, and Facility Identifier.

Country Code: nnn (ISO Standard, Reference web site URL: http://www.iso.org/iso/en/prods-services/iso3166ma/02iso-3166-code-lists/list-en1.html )

State Code: aa/nn (Federal Information Processing Standards Publication 5-2, Reference web site URL: http://www.itl.nist.gov/fipspubs/fip5-2.htm)

County Code: nnn (Reference web site URL: http://www.ncdot.org/services/personnel/salaryguide/CountyCodesbyCounty.html )

Facility Type: nn (range 0-9 digits). This range distinguishes the type of hospitals or community facility (0—for Government Hospitals, 1—for Private Hospitals, 2—for Private Nursing Homes, 3—Private Clinics, 4—for Retirement Communities, 5-9 for future enhancements.)

Facility Identifier: nnnn (It identifies a particular facility, e.g., a county has 500 nursing homes in it. A facility identifier identifies a particular nursing home's identity, e.g., its name and location within the county. The data captured with reference to Facility Identification is: Facility Name (e.g. XYZ Nursing Home or ABC Clinic), Address, Tel Number (Country Code, Area Code, Exchange Code, Telephone Number), Administrative Contact (Name, Tel No., e-mail address), Web site Address (URL), Specialty Area, and any other relevant information in an open data capture format.

Serial Number of Registration (SNR) : nnnnn (This SNR is issued to a patient when the patient visits a specific facility for any type of treatment, diagnosis or tests.) The serial number is in order of the patient visiting the facility on a specific date. Even if a patient visits a facility several times during the same day, several serial numbers can be issued, since a specific serial number is related to a specific visit and is inactivated after discharge of patient from the facility. Each serial number is valid only until the discharge with reference to the current visit.

Patient Registration Number (PRN): PRN has mapping to the date of registration and SNR of a patient.

Date : nn/nn/nnnn (mm/dd/yyyy format)

The data captured for patient identification contains: Patient Registration Number, patient name: last name (aaaaaaaaaaaaaaaaaa) MI(a) first name (aaaaaaaaaaaaaaaaaa) Telephone/Cellular phone number (nn/nnn-nnn-nnnn in country access code, area code, exchange code and Tel no format), e-mail address, Patient's Social Security Number (issued in USA), or Tax Identification Number (TIN), or any other Government issued identifier like Election Card Identification Number (issued in India) or Social Insurance Number (issued in North Korea), Address including State, City, Country, Street etc. and Medical Information, in an open data capture format.

The data so captured can be related to UIN, and upon inserting UIN, the patient identification data can be immediately retrieved by referencing to any previous record.

Search Optimizing Techniques: PRN may be issued to the patient at the time of registration at a particular facility type. The PRN is non-persistence number, and as soon as a patient departs a facility type, the PRN would be moved to archive. A patient may have more than one SNRs even at a single facility type, but SNR associates with date of visit at a facility type. Even if a patient visits a facility on a specific date, is issued at PNR and is then discharged, and if the same patient needs to revisit the same facility on the same day, another PNR would be issued. A patient's record is searched within a facility by use of PRN since PRN maps to date of registration and serial number of registration of the patient.

PRN is linked to various systems for diverse applications within the medical care providing facility. For instance, while implementing a local tracking system within the hospital using RFID or 802.11 technologies, PRN is attached to RFID or 802.11 patient-wearable tags within internal database local to the hospital. PRN/SNR maps to patient's data. When an alert is received for ‘out-of-bound,’ the PRN/SNR is used to retrieve patient identification data. Tracking application can be extended from local to global, by referencing with UIN.

UIN is a system and method to uniquely identify any person. The Universal Identification Number is a global reference identifier (GRI). The records related to PIN can be linked to UIN (Universal Identification Number). If these links are provided, then the overall system would be able to track and identify a patient all over the world. The interoperability of the system can be implemented globally, and that would allow the patient unrestricted mobility. For example, if a patient authorizes to make his/her medical data available online to authorized medical practitioners all over the world, pointers can be implemented so that such records may be accessed by authorized users: medical doctors, hospital personnel, and paramedics to deal with emergency situations in a timely manner. This shall also speed up diagnostics and treatment process.

A patient's record is searched with UIN by use of PIN references, since PIN maps to FIN and its associated Country Code, State Code, County Code, Facility Type, and Facility Identifier. For example, a facility identification number identifies a particular facility type, a private hospital, in the Orange County, N.C. USA as (example values indicated within braces): Country Code (897/US), State Code (37/NC), County Code (068), Facility Type (1), Facility Identifier (100).

In order to provide efficient search, we apply, inter alia, the Postal Index Number (PIN)/Zip Code (ZC)/Post Code(PC) Numbering System, as implemented in the postal departments of various nations. The postal identification numbers are already in force all over the world in the form of PIN Code, Postal Code, or ZIP Code. The format of the postal identification with PIN is in nine numeric, but ZIP code uses five numeric, and in some other countries (like Canada, Australia), alphanumeric fields are used.

The format of the PINCode/PostCode/ZipCode: Numeric PINCode/PostCode/ZipCode: nnnnnn, nnnnn or Alphanumeric field.

In order to get patient records in a timely manner, database system will be implemented in a way to allow search criteria based upon numeric or alphanumeric post code capability. The PIN/ZIP/PC Code system is based on geographical location that would allow us to narrow down searches of facilities where the patient data records may be available. That would be the situation when only the data related to patient visits to certain geography's is known. This is only one example of implementation to provide services to patients of different kinds. Since the system is technology/platform independent, it can be implemented to deal with various needs of society in different ways.

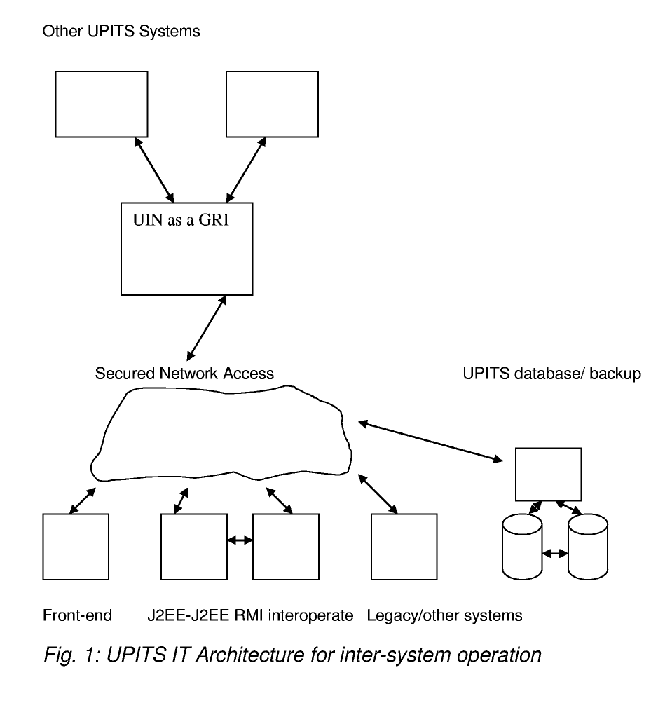

System IT Architecture: The UPITS system and method IT (Information Technology) Architecture would use J2EE (Java 2 Enterprises Edition), XML, RMI, and ORBs, but is not limited to use of just these technologies. The architecture is open and adaptable to new and emerging technologies. In case of Java to Java platform communication, the RMI (Remote Method Invocation) procedure can be used. To communicate from Java platform to any other platform, the CORBA (Common Object Request Broker Architecture) methods can be used. To communicate between platforms of any specific implementation to any other platform, the XML (extensible Markup Language) with embedded meta data tags can be used. Building on the XML interoperability, depending on the requirement of a particular situation, SOA (Service Oriented Architecture) with underlying layers of WSDL (Web Services Description Language) and SOAP (Simple Object Access Protocol) can be used. Therefore, in order to provide communication in different situations, implementation of above mentioned protocols and procedures can be used in any combination, or with new and emerging protocols, standards, and technologies. The UPITS IT Architecture is designed to embrace open standards and any new or emerging system or technologies based on open standards can be used to leverage this system for providing services to the patients in an effective manner. A representative architectural overview of UPITS System Inter operation is given in FIG. 1.

The UPITS database can also interoperate with legacy (healthcare applications based on old platforms or mainframes) systems. The cross-platform integration between legacy and other systems shall be provided by XML based intercommunication components as per guidelines outlined in HL 7 protocol, or with other new and emerging standards. The J2EE Systems can communicate with UPITS database through JDBC (Java Data Base Connectivity) compliance. All UPITS applications can be designed in a manner to inter operate with HIPPA compliant existing or upcoming systems to facilitate integration and modular expansion.

Database schema development: Among other records, the UPITS database schema captures the following, and a detailed description of the UPITS database schema is given in Attachment 1:
(1) Patient identification data, Address, Contact information.
(2) Emergency level medical data (that can be required by the paramedic/ambulance): Blood Type, Allergies to: medication, includes oral or injected, Allergies to: food intake, includes solid or liquid, Allergies to:

environmental factors like pollens, pollution, chemicals etc.
(3) Previous History of Significance: Descriptive field includes known pre-existing medical conditions of the patient. Classified as traumatic or non-traumatic like Asthma, Diabetes, Tuberculosis, Emphysema, Chronic Respiratory Failure, Heart Disease, Chronic Renal Failure, Cancer, Hypertension, Psychiatric Problems, Seizures, Tracheotomy, Other (not stated here), and Unknown.
(4) Current & previous medications, if any, include all within last six months.
(5) Primary attending physician contact details: Name, tel. no, e-mail address, name of clinic/hospital, date attended, treatment prsecribed (if any), lab investigations/tests done and results thereof (only significant details). Contact information and details of specialists and other physicians attending the patient.
(6) Examination and Test Reports: date of test or exam, lab/clinic where performed, by whom performed or observed, results, findings/observations.
(7) Pointers to other records: location and traceability of other medical records related to the patient. Location, URLs, procedure and important information to obtain them; and any other details of importance.

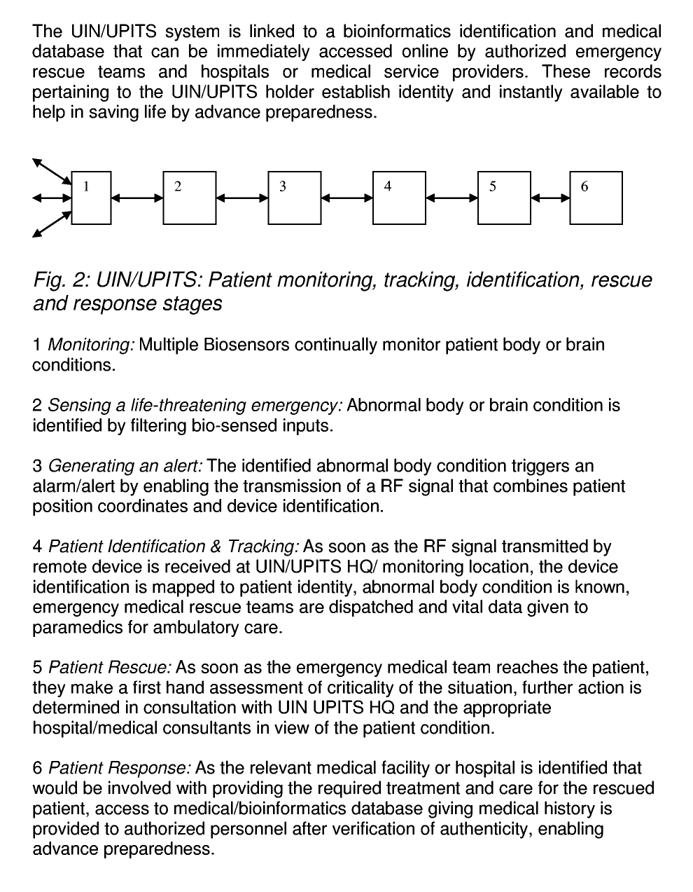

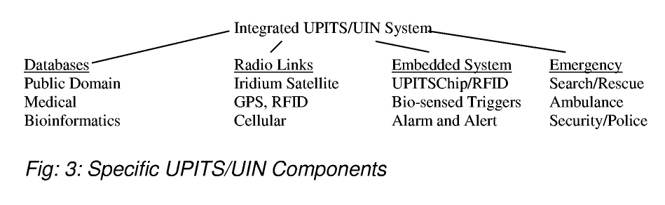

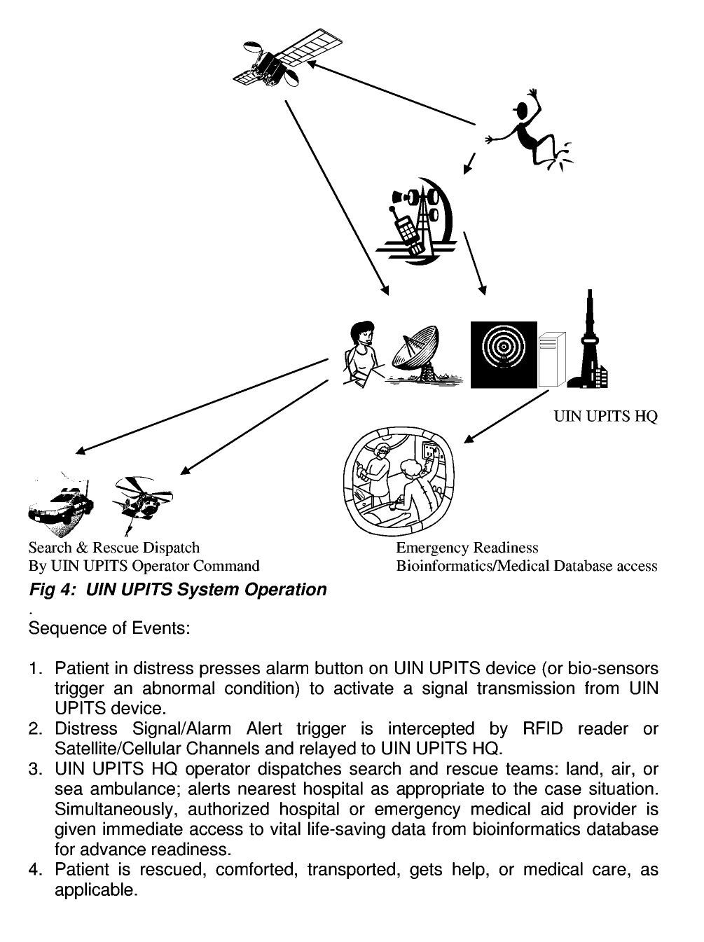

Futuristic Goals:
(1) The future enhancement of UPITS implementations would be to link all such databases globally by using UIN as the cross-reference GRI. When linked, grid computing technology can be leveraged to build patterns. Example can be relating disease to patient diet, habit, and life style over a diverse patient data across demographics, and aid in diagnosis by a global collaboration effort. An overview of database and system components is given in FIG. 3.
(2) An initiative can be launched to design and develop a micro chip that can become a patient life-saving device. The patient-wearable device can be linked to bio-sensing mechanism to monitor patient body and brain conditions, and upon sensing an abnormal condition, trigger alerts to a monitoring station. A brief schematic outlining various steps in this operation is shown at FIG. 2. Such a system can interoperate with UPITS to monitor and rescue patients globally. A pictorial description of such operational schematic is given in FIG. 4.

Privacy and Security Issues:
(1) The personal data related to the Unique Patient Identification and Tracking System are not available to anyone for access. All data can be updated periodically and made accessible at all times to authorized users only. The modification to data shall be done only by the appointed authorities upon appropriate verification for authenticity of modifications.
(2) If needed, additional privacy and security can be implemented by finger print enabled access to verify the authorized user or by use of any other suitable arrangement, as appropriate to the requirement of a specific project situation.

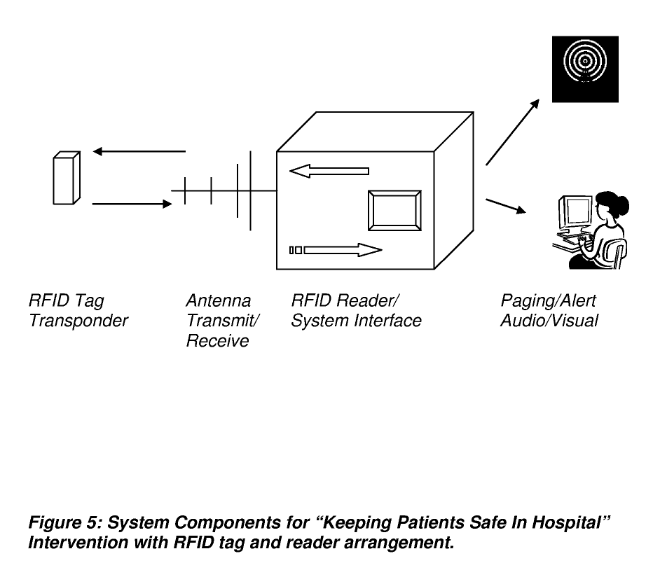

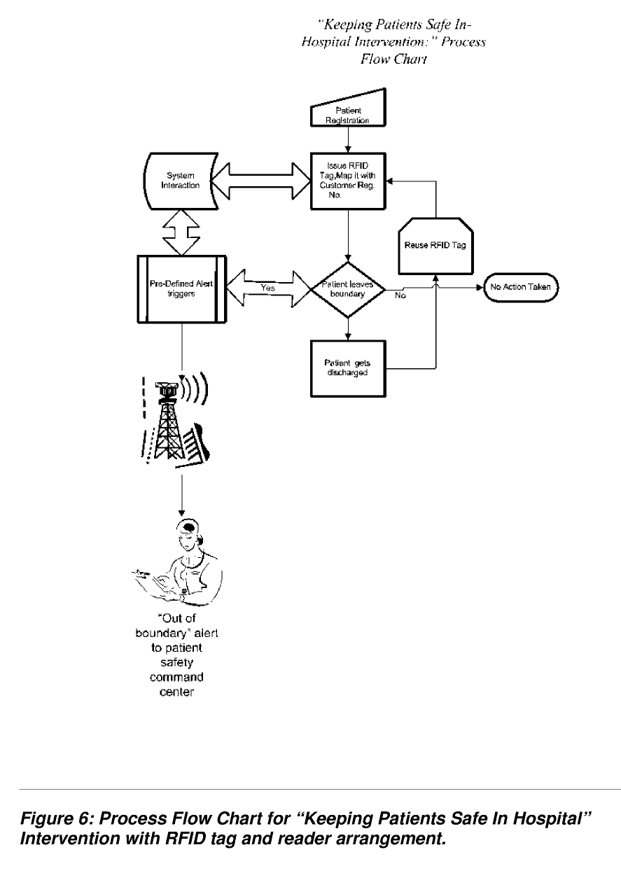

Sample System Implementation with RFID
(1) A RFID (Radio Frequency IDentification) reader device can be integrated with UPITS system to provide patient tracking over limited distance. Eventually, this can be extended and implemented globally with satellite and/or cellular or any other suitable technology to allow unrestricted mobility and freedom to at-risk patients. In a typical application, the signal radiated by the remote chip is received by suitable radio/satellite channels and transmitted to a base station. Vital data retrieved from a medical/bioinformatics database is made available to rescue agencies. Relevant patient medical records can be accessed by the hospital or emergency room for advance preparedness. Sample RFID implementation is shown in FIG. 5 and the system flowchart is shown in FIG. 6. Besides RFID, 802.11 Wireless LAN (Local Area Network) or other suitable technologies can also be used to achieve patient tracking and monitoring on a local basis.
(2) The initial objective of this invention is to create an effective patient identification and bioinformatics/medical database, monitor, and track patient movement within certain premises. Since the UPITS system is independent of the underlying technology, eventually it can be extended all over the world by annexing these patient data to the UIN (Universal Identification Number). A unique identification number shall be issued to all those who apply for it through a single controlling agency or a combination of several agencies, who work in coordination with each other so that they all follow the same system and method to avoid any redundancy and confusion. Such coordinated efforts of interacting agencies shall organize to reach and cover every human being on the planet in a phased manner.
(3) The unique identification number access code is internally mapped to authenticated data that has been received from the applicant. While the access code acts like the applicant's unique identification number, its internal mapping relates to three separate domains of data. Since the access code (PRN) is based on just the date and serial of check-in, complete privacy is maintained, yet providing the power and flexibility to identify the applicant when needed and provide all relevant information in times of a medical emergency.

Reference to Preceding Patent Application:
(1) This application is a related further work on the previously submitted “System and Method for Universal Identification of Biological Humans” vide 60/433,226, filing date Dec. 16, 2002 (provisional); subsequently submitted vide Ser. No. 10/745,333, filing date Dec. 12, 2003. The present application specifically builds on the previously submitted work in the area of patient safety, patient tracking, patient monitoring, and patient rescue.
(2) The current application is final submission of previously provisional application “System and Method for Patient Identification, Monitoring, Tracking, and Rescue” submitted vide 60/657,823 filing date Feb. 18, 2005 (Confirmation No. 5911).

### BACKGROUND OF THE INVENTION

(1) Field of the invention: Patient Identification, Tracking, Monitoring, and Rescue.
(2) Present invention relates to a system and method for uniquely identifying, tracking, monitoring, and rescuing patients.

### BACKGROUND ART

(1) Currently available systems do not specifically address the issue of a globally available patient identification, tracking, monitoring and rescue mechanism that be used to cover each and every patient on this planet, cross-reference patient recods, be available for implementation globally, and be technology/platform independent.
(2) Medical data related to the patient must be available upon requirement in the emergency situations to save human life. For example, a particular patient's blood type shall reveal an important data that can be crucial to saving time for an immediate medical treatment. Also, prior knowledge about allergies can prevent a wrong drug from being administered. Complete medical data can be of vital importance, and should be available at all times globally for patient medical reference. Most of currently available systems are stand-alone databases confined to specific medical care providers, with limited or no interoperability.
(3) Among existing systems for local patient tracking, some are based on obsolete techniques that severely limit patient freedom and mobility. For instance, a weight-driven sensor attached to patient bed would alert medical staff whenever the patient is off the bed.
(4) A prior art system for providing feedback about an individual patient for automated remote patient care is disclosed in U.S. Pat. No. 6,852,080 (issued Feb. 8, 2005). A medical device having a sensor for monitoring physiological measures of an individual patient regularly records a set of measures. A remote client processes voice feedback into a set of quality of life measures relating to patient self-assessment indicators. A database collects the collected measures set, the identified collected device measures set and the quality of life measures set into a patient care record for the individual patient. A server periodically receives the identified collected device measures set and the quality of life measures set from the medical device, and analyzes the identified collected device measures set, the quality of life measures set, and the collected device measures sets in the patient care record relative to other collected device measures sets stored in the database to determine a patient status indicator.
(5) A prior art tag and system for patient safety monitoring is disclosed in U.S. Pat. No. 6,144,303. The tag comprising an electronic circuit including an alarm circuit, having means for generating an alarm signal upon the capacitance measuring circuit detecting a level of capacitance corresponding to an alarm condition, whereby the outer surface of the housing is placed in contact with the patient, the capacitance measuring circuit detects an alarm condition when the patient is no longer in contact with the outer surface of the tag.
(6) A prior art system for providing interactive medical information display system and method for displaying user-definable patient events is disclosed in U.S. Pat. No. 5,447,164. An interactive medical information display system and method for displaying user-definable patient events is provided. The system includes a mechanism for acquiring physiological parameters from a patient and a mechanism for storing the parameters in a real-time database.
(7) A prior art system for determining a reference baseline of individual patient status for use in an automated collection and analysis patient care system is disclosed in U.S. Pat. No. 6,221,011. A set of collected measures is retrieved from a medical device adapted to be implanted in a patient. The collected device measure set includes individual measures which each relate to patient information recorded by the medical device adapted to be implanted during an initial time period. The collected device measures set is received from the medical device adapted to be implanted over a communications link which is interfaced to a network server. The collected device measure set is stored into a patient care record for the individual patient within a database server organized to store one or more patient care records.
(8) A prior art system for locating and communicating with a remote medical device implanted in an ambulatory patient is disclosed in U.S. Pat. No. 5,752,976. The system includes a telemetry transceiver for communicating data and operating instructions between the implanted device and an external patient communications device. The communications device includes a communication link to a remote medical support network, a global positioning satellite receiver, and a patient activated link for permitting patient initiated communication with the medical support network.
(9) All the above referenced inventions fulfill some need in overall patient care system. While each one of these systems is suitable to meet a specific, yet isolated objective, there is no comprehensive system that aids in global interoperation, linkage and cross-referencing of patient data.
(10) Most of the existing systems providing similar help require the patient to activate a communication channel and are confined to operate within the home. With UPITS, no human intervention would be required to generate alerts. The automatically received signal shall be immediately processed and rescue teams dispatched, as needed.
(11) This system (UPITS) can, in particular, benefit the patients suffering from Alzheimer's, infirm seniors, and all at-risk cases, including children.
(12) There is a need for a system and method for providing a universal way for capture of patient data, and provide a linkage and mechanism to take advantage of several isolated patient data records and bring their value for the benefit of patients. UPITS is the system that fulfills this gap and integrates several isolated and disparate patient data gathering procedures in a seamless manner. By virtue of its linkage to UIN as the Global Reference Identifier, UPITS system assures a continuous retrieval, transferal, and automated linkage of retrieved medical records, collected from any sources, relevant to a specific patient. This cross-referencing of medical records on a global basis aids in speeding up the diagnosis and treatment process. Also, grid computing can be effectively used to leverage UPITS system for building diagnostic patterns to help alleviate human suffering and disease.

### SUMMARY OF THE INVENTION

(1) The present invention is a system and method to uniquely identify, monitor, track, and rescue patients: UPITS (Unique Patient Identification and Tracking System).
(2) The patient data is captured at a Medical Care Providing Facility and identified by PIN (Patient Identification Number).
(3) The PIN comprises of FIN (Facility Identification Number) and PRN (Patient Registration Number).
(4) The PRN is a serial number issued at a specific facility on a specific date to all visiting patients.
(5) The patient medical records related to all PIN can be cross-referenced by UIN (Universal Identification Number).
(6) The PRN can be linked to various applications with the medical facility, like a patient tracking system.
(7) The PIN and UIN combination can retrieve all medical records associated with a particular patient on a global basis.
(8) Access to UPITS database shall be restricted to only authorized users.
(9) The UIN/UPITS system shall interoperate in a manner that protects the privacy and security of the patients.

### BRIEF DESCRIPTION OF THE ATTACHMENTS AND FIGURES ENCLOSED

(1) Attachment 1 gives details of the Database Schema for UPITS System.

(2) FIG. 1 shows the representative Overall IT (Information Technology) Architecture for the UPITS system and its interoperability with other systems. Cross-referencing through UIN is also shown in the figure.

(3) FIG. 2 shows the various stages in complete patient monitoring, identification, tracking, rescue, and response cycle.

(4) FIG. 3 shows various components of the overall UIN/UPITS system.

(5) FIG. 4 shows the patient monitoring, rescue and response system on a global basis.

(6) FIG. 5 shows the patient tracking implementation using RFID (Radio Frequency Identification) technology for a patient safety intervention within a medical care providing facility.

(7) FIG. 6 shows a flowchart for various events in a patient tracking and rescue application with RFID technology for patient safety intervention within a medical care providing facility.

### ADVANTAGES OF THE INVENTION

(1) This invention provides a unique method to capture, store, retrieve, relate, and interpret patient data on a global scale.
(2) This invention fulfills a need to integrate various islands of patient data and provide inter operability on a global scale.
(3) Within the medical care providing facility, this invention can be integrated with a suitable tracking technology like RFID, 802.11 etc. to implement a patient safety intervention.
(4) By referencing with UIN, the global reference identifier, patient data records can be interlinked and relevant information can be extracted by grid computing on a global scale, to aid in patient diagnostic and draw patterns. Such patterns can be used to relate human habits to disease. This can be useful to alleviate human suffering.
(5) Patient identification and tracking can effectively be used to rescue at-risk patients like those suffering from Alzheimer's.
(6) Within hospitals, patient tracking and rescue interventions can allow more freedom and mobility to at-risk patients.
(7) Future implementations with this invention can globally monitor, track, and rescue patients, thus providing them greater mobility and freedom.

Attachment-1, UPITS Database Schema: UPITS database schema clearly and unambigiously defines various data fields that are required to capture a patient record. These fields include the Patient Identification Data; Emergency Medical Data; Data collected by paramedic at the spot when called for to attend the patient; details of Routine medical test results: indicated each with date and facility location of where performed; details of each dated physician/doctor/medical care provider observation/s and diagnosis; Pointers to additional/detailed medical records: Location, URLs, procedure and important information to obtain them. While it may not always be either possible or feasible to get all of the following records, sincere attempts must be made to capture as much data related to the patient as possible. This database schema accommodates description of any records or history or other details about the patient that may be considered important, but was not covered in details of the schema. When the cause of an injury, medical condition or accident can not be established or known, it would be considered appropriate to write the term: “Unknown.” When the patient visits a medical care providing facility, and if the previous records related to the patient are available in the database of that facility, then the only data that needs to be captured is the one that is relevant to current patient visit. Duplication and redundancy of data needs to be avoided by careful consideration while capturing data, yet ensuring that all important and relevant details have been gathered. The data shall be captured in open standards based on ISO format in order to ensure global interoperability and compatibility. The database schema is independent of the underlying implementation technology and can be adapted to any platform.

Following is a description of the various data fields: Patient identification data: PIN (as issued at the medical care providing facility), UIN (if UIN has been issued for this patient), Name, SSN#, Address (current, permanent with Tel. Nos.)

Emergency level data (required by the paramedic/ambulance):
(1) Blood Type
(2) Allergies to: medication, includes oral or injected
(3) Allergies to: food intake, includes solid or liquid
(4) Allergies to: environmental factors like pollens, pollution, chemicals etc.
(5) Previous History of Significance: Descriptive field includes known pre-existing medical conditions of the patient. Classified as traumatic or non-traumatic like Asthma, Diabetes, Tuberculosis, Emphysema, Chronic Respiratory Failure, Heart Disease, Chronic Renal Failure, Cancer, Hypertension, Psychiatric Problems, Seizures, Tracheotomy, and any other (not stated here), or Unknown.
(6) Current medications, if any, include all
(7) Previous medications (within last six months, and earlier; captured in two fields:

a. Previous six months: with dates administered, and b. Others: with dates administered)
(8) Primary attending physician contact details: Name, tel. no, e-mail address, name of clinic/hospital, date attended, diagnosis and treatment prescribed (if any), lab investigations/tests done and results thereof (only significant details).

The details are to be captured in dated sequence for all diagnosis/treatment.
(9) Other Physicians attended: Contact information and details of specialists and other physicians attending on the patient, details of their diagnosis and prescribed treatment, if any; significant details of lab test results. The details are to be captured in dated sequence for all diagnosis/treatment, as available.

Data collected by paramedic at the spot: Time call received, Time of arrival at patient site, Time of leaving patient site, Time of arrival at hospital/emergency room, Paramedic ID # and Affiliation.
(1) On spot assessment: Description of the assessment and statement if any Pre-Existing Condition, whether traumatic or non-traumatic may have led to the present condition/injury and mechanism of Injury, if any and External cause of injury.
(2) Details about injury to indicate whether it is Aircraft related accident, Assault, Bike accidents, Bites, Burns-Thermal/Chemical, Chemical poisoning, Drowning, Drug poisoning, Electrocution (Non-lightning), Excessive cold or heat, Falls, Firearms injury, Lightning, Machinery accidents, Mechanical suffocation, Motor vehicle accidents (public/non-public roads), Pedestrian traffic accident, Radiation exposure, Smoke inhalation, Sports injury, Stabbing, venomous stings (plants or animals), water transport accidents, Other, or Unknown. Gather as much detail as possible.
(3) Injury Description:
Clinical description of injury type and body site.
Body Site Classification:
Head only (excluding neck, cervical spine, and ear), Face (including ear), Thorax (excluding thoracic spine), Abdomen (excluding thoracic spine), Spine, Hand and/or arm, Foot, Leg, or bony pelvis, unspecified body region.
(4) Injury Type Classification:
Swelling/bruising, Blunt Injury, Laceration, Deformity, Puncture/Stab, Gunshot, Amputation, Crush, or Burn.
(5) If a snake, animal or insect bite, identify the species and other identification characteristics of the animal/insect/bird, like the type, color, length and other identification parameters related to the snake and other information that can help.
(6) Signs and Symptoms: Signs and symptoms reported or observed.
(7) Impression: Paramedic's clinical impression which led to the management given to the patient (treatments, medications, or procedures).
(8) Blood Pressure: Patient's systolic/diastolic blood pressure
(9) Pulse Rate: Patient's palpated or auscultated pulse rate expressed in number per minute.
(10) Respiratory Rate: Patient's unassisted respiratory rate expressed as a number per minute.
(11) Respiratory Effort: Patient's respiratory effort Classified as Normal, Increased-Not Labored, Increased-Labored OR Decreased-Fatigued, or Absent.
(12) Skin Perfusion: Patient's skin perfusion, expressed as normal or decreased.
(13) Glasgow Coma Scale: Given a reliable, objective way of recording the conscious state of a person. It can be used for patient assessment and is valuable in predicting the ultimate outcome.
(14) Last Physician attended (if any): Name, contact details, treatment. List if this information is additional to the one provided above.
(15) Any other significant observations, findings or remarks:

Routine medical test results; indicate each with date and facility location of where performed.

Blood tests/Hematology (Ref: ‘Oxford Handbook of Clinical Medicine,’ ISBN # 0-19-261 735-4, pp 761), Measurement/Reference Interval:

| | |
|---|---|
| White Cell Count | 4.0-11.0 × 10\hat{ }9/1 |
| Red Cell Count | Male 4.5-6.5 × 10\hat{ }12/1 |
| | Female 3.9-5.6 × 10\hat{ }12/1 |
| Hemoglobin | Male 13.5-18.0 g/dl |
| | Female 11.5-16.0 g/dl |
| Packed Red Cell Volume (PCV) | Male: 0.4-0.54 l/l |
| | Female: 0.37-0.47 l/l |
| Mean Cell Volume (MCV) | 76-96 fl |
| Mean Cell Hemoglobin (MCH) | 27-32 pg |
| Mean Cell Hemoglobin | 30-36 g/dl |
| Concentration (MCHC) | |
| Neutrophils | 2.0-7.5 × 10\hat{ }9/l; 40-75% wcc |
| Lymphocytes | 1.3-3.5 × 10\hat{ }9/l; 20-45% wcc |
| Eosinophils | 0.04-0.44 × 10\hat{ }9/l; 1-6% wcc |
| Basophils | 0.0-0.10 × 10\hat{ }9/l; 0-1% wcc |
| Monocytes | 0.2-0.8 × 10\hat{ }9/l; 2-10% wcc |
| Platelet count | 150-400 × 10\hat{ }9/l |
| Reticulocyte count | 25-100 × 10\hat{ }9/l |

Full Blood Chemistry: (Measurement/Reference Interval)

| | | |
|---|---|---|
| Glucose | 65-109 | MG/DL |
| Fructosamine | 1.8-2.5 | MMOL/L |
| HB AIC | 4.3-6.1% | |
| BUN | 5.0-25.0 | MG/DL |
| Creatinine | 0.5-1.5 | MG/DL |
| Calcium | 8.5-10.5 | MG/DL |
| LDH | 100-240 | U/L |
| Alk. Phos. | 20-115 | U/L |
| Bili. Tot | 0.1-1.5 | MG/DL |
| AST (SGOT) | 0-41 | U/L |
| ALT (SGPT) | 0-45 | U/L |
| GGT (GGPT) | 2-65 | U/L |
| Tot. Protein | 6.5-8.5 | G/DL |
| Albumin | 3.6-5.0 | G/DL |
| Globulin | 1.0-4.5 | G/DL |
| Cholesterol | 140-220 | MG/DL |
| HDL Cholesterol | 35-55 | MG/DL |
| LDL (Calculated) | 0-129 | MG/DL |
| Triglycerides | 0-150 | MG/DL |

Urinalysis (Measurement/Reference Interval):

| | |
|---|---|
| Glucose | Negative (GM %) |
| Protein | 0-20 MG % |
| Leukocyte Screen | Negative |
| Hemoglobin Screen | Negative |
| White Blood Cells | 0-10/HPF |
| Red Blood Cells | 0-2/HPF |
| Granular Casts | 0-5/(40LPF) |
| Hyaline Casts | 0-5/(40LPF) |
| Urine Temperature | 90.5-99.6 degrees F. |
| Creatinine | 10-300 MG/DL |
| Prot/Creat | 0-200 MG/GMCR |
| PH Value | Alkaline 6.8-7.2 |

Special Tests, if any, like T3/T4/TSH etc. or any other pertinent to patient current or past condition.

Pointers to additional/detailed medical records: Location, URLs, procedure and important information to obtain them.

Any other details of importance not covered above. This can include description of any records, history, observations, or other items about the patient.

Primary attending physician contact details: Name, tel. no, e-mail address, name of clinic/hospital, date attended, treatment prsecribed (if any), lab investigations/tests done and results thereof (only significant details). Contact information and details of specialists and other physicians attending on the patient. When a patient visits a hospital, he/she will be registered at the registration counter. The patient would be assigned a serial number that would be unique for the day.

What is claimed is:

1. UPITS (Unique Patient Identification and Tracking System) is a system and method that uniquely identifies a patient and makes a provision to capture, store, and share critical medical/bioinformatics data related to the patient to the authorized users in a secure manner. The overall system is technology/platform independent, and can operate either by itself when ported on a suitable computer system or in combination with a sensing and/or tracking mechanism. When used with a sensing and/or tracking mechanism, depending on the technology used, the patients can be monitored, tracked, and rescued by suitable alert triggers built into the system.

2. The method in accordance with claim 1, wherein the patient is uniquely identified by issue of PIN (Patient Identification Number) and this number is used as an identifier to capture, store, and retrieve patient data or records. The PIN consists of various fields that clearly and unambiguously identify the medical/care providing facility, its location, the date of patient registration, and patient specific identification serial number. The PIN comprises of two major parts: FIN (Facility Identification Number) and PRN (Patient Registration Number). The FIN, followed by PRN makes the PIN.

3. The method in accordance with claim 2, wherein the patient is registered at a medical care providing facility, and that facility is uniquely identified by issue of a FIN (Facility Identification Number). The FIN distinguishes the type of facility: e.g, governement hospital, private hospital, nursing homes, etc. The Facility Identification Number (FIN) comprises of the fields: Country Code, State Code, County Code, Facility Type, and Facility Identifier.

4. The method in accordance with claim 2, wherein PRN (Patient Registration Number) is issued at the time of registration at a hospital, nursing home, or any other medical care providing facility. The PRN internally maps to the date of registration and SNR (Serial Number of Registration). The PRN (Patient Registration Number) is activated during the stay of patient at the medical care providing facility.

5. The method in relation to claim 1, wherein data related to the patient is captured in a database, in accordance with a database schema. The database schema details the unique fields of records that need to be captured in relation to the patient medical/bioinformatics data.

6. The method in relation to claim 1, wherein the identification and medical data related to the patient can be linked to UIN (Universal Identification Number) that is a unique identifier for the biological humans. The UIN is used in this context as a GRI (Global Reference Indicator).

7. The method in relation to claim 2, wherein the unique data pertaining to specific patient records identified by PIN can be cross-referenced globally by linking each patient record to UIN for aiding in diagnosis and treatment.

8. The method in relation to claim 1, wherein the UPITS system can be linked to a sensing and tracking mechanism, the patients can be identified, tracked, monitored, and rescued, when the inbuilt alerts warn about an alarming patient situation: an abnormal body condition, wandering to an out-of-bound area, life threatening emergency etc.

9. The method in relation to claim 8, wherein the UPITS software architecture shall be platform/technology independent, any suitable technology like (but not limited to) RFID (Radio Frequency Identification), Wireless LAN (Local Area Network) based on IEEE 802.11 standard, Metropolitan Area Network (MAN), Power Line LAN, Cellular Radio Networks, Low Earth Orbit (LEO) Satellites, Geo-Stationary Satellites, Tera-Hertz Magnetism, or a combination of these technologies with each-other or other techniques, can be used for enabling the patient tracking mechanism.

10. The method in relation to claim 8, wherein the UPITS system can be leveraged to operate in a manner that enables the detection of bio-sensed signals from patient-wearable devices, and the transmission of these signals to detection center through an underlying transmission technique, the bio-sensed signals can be monitored for appropriate range and alerts can be issued to rescue the patient when an abnormality is detected.

11. The method in relation to claim 8, wherein the bio-sensing shall be performed by patient wearable devices, and when an abnormal condition is detected, the alarm signal with detail of abnormality shall be transmitted in the form of a data packet that also contains the patient identification and location data.

12. The method in relation to claim 11, wherein the location data can be either calculated on-board the patient wearable device by receiving global positioning signal through GPS satellites, or can be calculated at a central location by calculation of the Doppler Shift or any other suitable location technology or reverse triangulation techniques, in a manner that such arrangements would be effective in overall operation and performance of the system.

13. The method in relation to claim 1, wherein the patient records residing in any database globally, including the legacy databases, can be cross-referenced by relating each record to UIN as the GRI, and using XML (extensible Markup Language) or a suitable open standard technology for accessing and relating these records.

14. The method in relation to claim 1, wherein the patient records from any database can be accessed by using XML or open standard technology and UIN as the GRI, a suitable provision can be made in the UIN database to link pointers to all the records pertaining to a specific patient, for ease of searching and cross-referencing.

15. The method in relation to claim 14, wherein the cross-referenced global patient data can be correlated and processed on grids for aiding research in diagnosis of specific ailments, in a manner that ensures the privacy and confidentiality of the individual patients, to help in finding solutions to alleviate human suffering.
